(19) United States
(12) Patent Application Publication
(10) Pub. No.: US 2026/0008656 A1
(43) Pub. Date: Jan. 8, 2026

(54) Wear Pad Assembly

(71) Applicant: Caterpillar Inc., Peoria, IL (US)

(72) Inventors: Richard David Nicholas SURTEES, Leicestershire (GB); Robin Jonathan HOLDEN, Leicestershire (GB)

(73) Assignee: Caterpillar Inc., Peoria, IL (US)

(21) Appl. No.: 18/879,937

(22) PCT Filed: Jun. 27, 2023
(86) PCT No.: PCT/US2023/069185

§ 371 Date: Dec. 30, 2024

(30) Foreign Application Priority Data
Jul. 8, 2022 (GB) 2210094.5

(51) Int. Cl. B66F 9/065; B66C 23/70; F16C 29/02

(52) U.S. Cl. CPC B66F 9/0655; F16C 29/02; B66C 23/707

(57) ABSTRACT

Wear pad assembly for an extendable boom having a first boom section and a second boom section. The wear pad assembly comprises an anchor for mounting to the first boom section. The anchor comprises a pin extending between a first end and a second end along a longitudinal axis. The anchor further comprises a connecting portion extending outwardly from the first end of the pin in a plane perpendicular to the longitudinal axis, the connecting portion comprising a connecting aperture. The wear pad assembly further comprises a wear pad having a thickness extending between a coupling surface and an opposing sliding surface, the coupling surface comprising a recess for engagement with the pin of the anchor (30). The wear pad assembly comprises an adjuster for adjusting the position of the wear pad along the pin in a direction parallel to the longitudinal axis, the adjuster having a contact end that is inserted through the connecting aperture and contacts the coupling surface of the wear pad.

### TECHNICAL FIELD

This disclosure is directed towards a wear pad assembly for an extendable boom, and a machine or telehandler comprising such a wear pad.

### BACKGROUND

Machines such as telehandlers (also known as telescopic handlers or roto telehandlers) typically comprise a lifting arm. These lifting arms are used to lift, carry and place materials around construction sites, agricultural sites and the like. The lifting arm typically comprises an extendable boom or telescopic cylinder to which a work tool, such as a fork or bucket, can be attached. The extendable boom comprises a main boom section attached to the main body of the telehandler via a hinge, and a telescopic boom section mounted in the main boom section. The telescopic boom section is slidable along the main boom section between retracted and extended orientations. The telehandler may have further telescopic boom sections mounted within the telescopic boom section.

One or more sacrificial and replaceable wear pads are typically located between two sliding telescopic sections, to prevent wear of the telescopic sections, to reduce friction, and to take up gaps between the telescopic sections. Due to variation in fabrication tolerances, shims are commonly used to achieve desired wear pad running clearances between sliding telescopic sections. Shims may also be used to maintain desired running clearances during the lifetime of a wear pad, thereby prolonging the lifetime of the wear pad. Alternatively, US-A-2016/0130119 discloses the use of a threaded adjuster instead of shims to achieve and maintain desired wear pad running clearances between sliding telescopic sections.

There is an ongoing need to improve the structure of wear pad assemblies for telescopic sections, to increase the ease with which the wear pad assembly can be adjusted. A particular need is to reduce servicing costs, which can be relatively high due to the cost of the skilled labour required in the servicing of telehandlers. Furthermore, many telehandlers are rented to operators and thus reduced service or down time would be particularly beneficial.

### SUMMARY

The present disclosure provides a wear pad assembly for an extendable boom having a first boom section and a second boom section, the wear pad assembly comprising: an anchor for mounting to the first boom section, the anchor comprising a pin extending between a first end and a second end along a longitudinal axis, the anchor further comprising a connecting portion extending outwardly from the first end of the pin in a plane perpendicular to the longitudinal axis, wherein the connecting portion comprises a connecting aperture; and a wear pad having a thickness extending between a coupling surface and an opposing sliding surface, the coupling surface comprising a recess for engagement with the pin of the anchor; and an adjuster for adjusting the position of the wear pad along the pin in a direction parallel to the longitudinal axis, the adjuster having a contact end that is inserted through the connecting aperture and contacts the coupling surface of the wear pad.

Optionally, the recess engages with the pin such that the wear plate engages with the base plate but is detached from it.

Optionally, the recess is configured to provide a clearance fit with the pin, in particular wherein the recess is sized and/or shaped to provide the clearance fit with the pin.

Optionally, the pin and the recess are circular.

Optionally, an outer surface of the pin is smooth.

Optionally, a perimeter of the sliding surface of the wear pad comprises a chamfer.

Optionally, the adjuster is configured to be lockable.

Optionally, the adjuster comprises a threaded bolt with a locking nut.

Optionally, the wear pad assembly comprises two or more adjusters.

Optionally, the wear pad assembly further comprises a washer positioned between the coupling surface of the wear pad and the contact end of the adjuster.

Optionally, the wear pad comprises a locating feature for locating and/or retaining the washer on the wear pad.

Optionally, the locating feature comprises an annular flange extending from the coupling surface of the wear pad in a direction perpendicular to a plane of the coupling surface, the annular flange extending around the wear pad recess, and the washer comprises a washer aperture, the washer aperture being sized to fit around the annular flange.

Optionally, the washer aperture is sized to provide a clearance fit with the annular flange.

Optionally, the washer aperture is sized to provide an interference fit with the annular flange.

The present disclosure further provides an extendable boom having a first boom section and a second boom section, the extendable boom comprising the aforementioned wear pad assembly.

Optionally, the wear pad assembly is mounted to the first boom section and the second boom section is configured to slide relative to the first boom section along the sliding surface of the wear pad.

Optionally, the wear pad is positioned on a first side of the first boom section, the wear pad being located between the first boom section and the second boom section, and the anchor is mounted to a second opposing side of the first boom section, the pin extending through a first boom aperture in the first boom section and into the wear pad recess.

Optionally, the wear pad is constrained in a direction perpendicular to a plane of the first boom section by the contact end of the adjuster and the second boom section.

The present disclosure further provides a telehandler comprising the aforementioned extendable boom.

### BRIEF DESCRIPTION OF THE DRAWINGS

Embodiments of the present disclosure will now be described, by way of example only, with reference to the accompanying drawings, in which:

FIG. 1 shows a schematic side elevation of a telehandler comprising a wear pad assembly in accordance with the present disclosure;

FIG. 2 shows an exploded perspective view of a wear pad assembly in accordance with the present disclosure;

FIG. 3 shows a perspective cross-sectional view of the wear pad assembly of FIG. 2, mounted to a first boom section; and

FIG. 4 shows a side cross-sectional view of the wear pad assembly of FIGS. 2 and 3, mounted to a first boom section and facing a second boom section.

### DETAILED DESCRIPTION

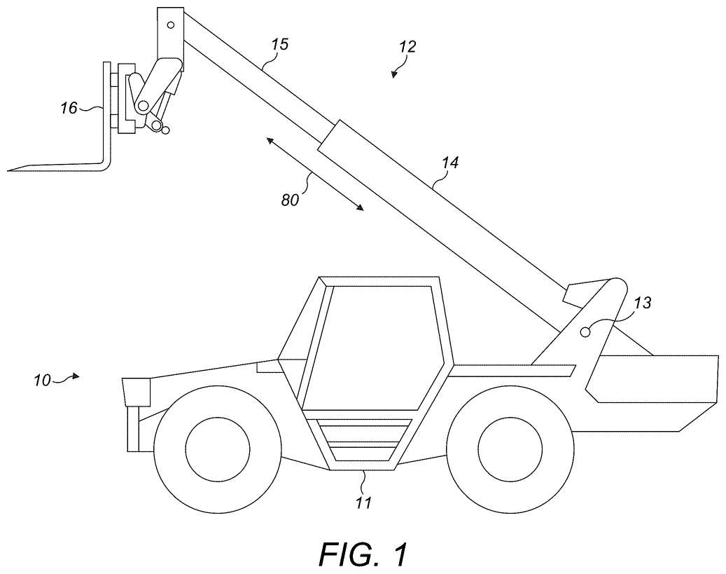

FIG. 1 illustrates a telehandler 10 comprising the wear pad assembly 20 of the present disclosure (not visible in FIG. 1). The telehandler 10, also known as a telescopic handler, may be any type of telehandler, such as a roto or rotating telehandler. The telehandler 10 may comprise a chassis or main body 11 and a boom 12 mounted thereto at a boom hinge 13. The boom 12 may comprise a main boom section 14 and a telescopic boom section 15 mounted to the main boom section 14. The telescopic boom section 15 may be retractably mounted inside the main boom section 14 such that the telescopic boom section 15 is slidable relative to the main boom section 14 along a sliding direction 80. Although not shown in FIG. 1, a further telescopic boom section may be retractably mounted inside the telescopic boom section 15 such that the further telescopic boom section is slidable relative to the telescopic boom section 15 along the sliding direction 80. A work tool 16, in this case a fork, may be attached to the telescopic boom section 15 for performing work.

At least one wear pad assembly 20 may be located between the main boom section 14 and the telescopic boom section 15, such that the boom sections 14,15 may slide relative to one another along a wear pad 40 of the wear pad assembly 20. The at least one wear pad assembly 20 may prevent wear of the boom sections 14,15 from the sliding motion, reduce friction, and increase stability of the boom 12 by taking up gaps between the boom sections 14,15. Typically a plurality of wear pad assemblies 20 may be provided between the boom sections 14,15. For example, for typical square boom sections 14,15, one or more wear pad assembly(ies) 20 may be provided on each of two opposing sides, or even on all four sides, of the main boom section 14 or the telescopic boom section 15. Furthermore, wear pad assemblies 20 may be provided at both upper and lower ends of the boom sections 14,15. The following description in relation to a single wear pad assembly 20 may equally apply to some or all of the other wear pad assemblies 20.

The wear pad assembly 20 may be mounted to the main boom section 14 such that the telescopic boom section 15 slides along it, or the wear pad assembly 20 may be mounted to the telescopic boom section 15 such that the main boom section 14 slides along it. The boom section 14, 15 to which the wear pad assembly 20 is mounted will be referred to herein as the first boom section 21 and the boom section 14, 15 that slides along the wear pad assembly 20 will be referred to herein as the second boom section 22. There may be no contact between the boom sections 14, 15 during extension and retraction other than via the wear pad assembly(ies) 20.

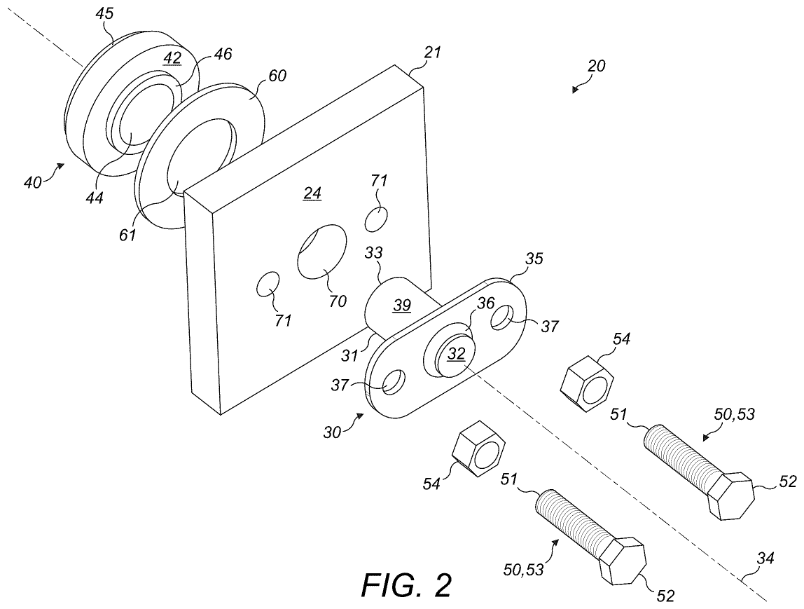

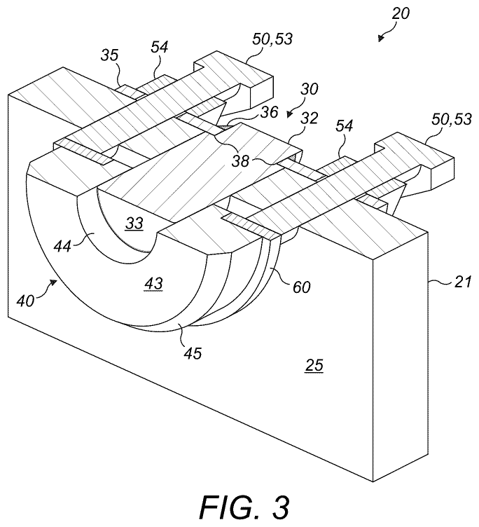

As shown in FIGS. 2 to 4, the wear pad assembly 20 generally comprises an anchor 30, a wear pad 40, and an adjuster 50.

The anchor 30 may comprise a pin 31 extending between a first end 32 and a second end 33 along a longitudinal axis 34. The pin 31 may have a circular transverse cross-section (that is, perpendicular to the longitudinal axis 34), as shown in the specific embodiment of FIGS. 2 to 4. Alternatively, the pin may have a cross-section that is square, triangular, another polygonal shape, or an irregular shape. An outer surface 39 of the pin 31 may be smooth. In particular, the outer surface 39 of the pin 31 may be threadless. The pin 31 may be hollow or solid.

The first end 32 of the pin 31 may be provided with a connecting portion 35. The connecting portion 35 may comprise a planar element extending outwardly from the first end 32 of the pin 31 in a plane perpendicular to the longitudinal axis 34. The connecting portion 35 may extend outwardly from the whole perimeter of the pin 31, as illustrated in FIG. 2. Alternatively, the connecting portion 35 may extend outwardly from only a part of the perimeter of the pin 31, for example from one side of the perimeter of the pin 31 or from opposing sides of the perimeter of the pin 31. The pin 31 and the connecting portion 35 may be separate parts joined together by known means, such as via a weld 36 as shown in the specific embodiment of FIGS. 2 to 4. As further shown in the specific embodiment of FIGS. 2 to 4, the first end 32 of the pin 31 may be provided with a stepped shoulder 38 that may act as an abutment for locating the separate connecting portion 35 on the pin 31. Alternatively, the pin 31 and the connecting portion 35 may be fabricated as a unitary element.

The anchor 30 may be configured to be releasably mounted to the first boom section 21. For example, as shown in FIGS. 2 to 4, the connecting portion 35 may comprise at least one connecting aperture 37. As shown in the specific embodiment of FIGS. 2 to 4, two spaced apart connecting apertures 37 may be provided. As further shown, the two connecting apertures 37 may be located towards opposing ends of the connecting portion 35.

The anchor 30 may be formed from any suitable material. In particular, the anchor 30 may be formed from any type of weldable steel.

The wear pad 40 may extend across a thickness 41 between a coupling surface 42, which may face the first boom section 21, and an opposing sliding surface 43, which may be configured for the second boom section 22 to slide therealong. Hence the wear pad 40 may be coupled to the first boom section 21, and the second boom section 22 may be configured to slide relative to the first boom section 21 along the sliding surface 43 of the wear pad 40, particularly in the sliding direction 80. In the present disclosure the term “coupled” means any type of engagement, such as for example two parts contacting each other (directly or indirectly) or one part resting on another part, and does not connote or imply any form of attachment.

The wear pad 40 may be a plate and the dimensions across the coupling and/or sliding surfaces 42,43 may be substantially greater than the thickness 41. The mounting and/or sliding surfaces 42,43 may be substantially circular and the wear pad 40 may be substantially cylindrical, although other shapes are possible. For example, the mounting and/or sliding surfaces 42,43 may be substantially square or rectangular and the wear pad 40 may be a substantially square or rectangular cuboid.

The coupling surface 42 of the wear pad 40 may be provided with a recess 44 for engaging with the pin 31 of the anchor 30. That is, the recess 44 may be shaped and sized to fit around the pin 31. As shown in the specific embodiment of FIGS. 2 to 4, the recess 44 may be circular (that is, it may have a circular transverse cross-section), to correspond with the circular shape of the pin 31. A circular pin 31 and recess 44 may be advantageous so that a particular rotational orientation of the wear pad 40 relative to the pin 31 is not required to achieve engagement between the recess 44 and the pin 30. Alternatively, a square or other polygonal shaped pin 31 and recess 44 may be advantageous if a particular rotational orientation of the wear pad 40 relative to the pin 31 is desired. The recess 44 may be a through recess, such that it penetrates through the thickness of the wear pad 40, as illustrated in the specific embodiment shown in FIGS. 2 to 4. Alternatively, the recess 44 may be a blind recess, such that it does not penetrate through the thickness of the wear pad 40.

The recess 44 may be configured to provide a clearance fit with the pin 31 of the anchor 30, such that the wear pad 40 may be assembled with the anchor 30 (and subsequently disassembled) without the need for force or the use of a tool. In particular, the recess 44 may be shaped and/or sized to provide a clearance fit with the pin 31 of the anchor 30. The term “clearance fit” is used herein to mean that the dimensions of a hole and a shaft are such that a clearance or gap exists between the hole and the shaft when they are assembled; that is to say, the hole is larger than the shaft. Thus the recess 44 may be larger than the pin 31.

One or more edges of the perimeter of the sliding surface 43 of the wear pad 40 may be provided with a chamfer 45. As illustrated in the specific embodiment of FIGS. 2 to 4, for a circular wear pad 40 the entire perimeter edge of the sliding surface 43 may be provided with a chamfer 45. In the case of a rectangular or other polygonal wear pad 40 (not shown), the two leading edges of the perimeter of the sliding surface 43 of the wear pad 40 (relative to sliding direction 80) may be provided with a chamfer 45. However, any number or all of the edges of the perimeter of the sliding surface 43 of the wear pad 40 may be provided with a chamfer 45. The chamfer 45 may aid in reducing friction by providing a transitional edge to the wear pad 40. The chamfer 45 may also serve as an indicator for monitoring the wear of the wear pad 40. For example, the wear pad 40 may be replaced when the sliding surface 43 of the wear pad 40 has worn away such that the chamfer 45 is no longer visible.

The wear pad 40 may comprise a suitable pad material for wearing away during use. The pad material may have a lower hardness than the boom sections 21,22 (14,15), such that the wear pad sacrificially wears away rather than the boom sections 21,22 (14,15). The pad material may, for example, comprise nylon.

One or more adjusters 50 may be provided for adjusting the position of the wear pad 40 in the direction of the longitudinal axis 34 when the wear pad 40 is assembled with the anchor 30 by engaging the wear pad 40 recess 44 with the anchor 30 pin 31. The adjuster 50 may be operable to urge the wear pad 40 along the pin 31, in a direction from a first end 32 of the pin 31 towards the second end 33 of the pin 31. The adjuster 50 may have a contact end 51 for contacting the wear pad 40 (directly or indirectly) and an opposing adjustment end 52. A length of the adjuster 50 may be longer than a length of the pin 31. The adjuster 50 may be configured to be lockable, such that when the adjuster 50 is locked the wear pad 40 may be prevented from moving closer to the pin 31. The adjuster 50 may also serve as a fastener to secure the anchor 30 to the first boom section 21. Alternatively, the adjuster 50 may not secure the anchor 30 to the first boom section 21 and instead separate fasteners for this purpose may be provided (not shown).

As shown in the specific embodiment of FIGS. 2 to 4, the adjuster 50 may comprise a threaded bolt 53. The adjustment end 52 of the threaded bolt 53 may, for example, comprise a hexagonal head for adjustment by a spanner or a socket cap (also known as an Allen head) for adjustment by an Allen wrench. The threaded bolt 53 may be provided with a locking nut 54 to lock the bolt 53 in position. As further shown in the specific embodiment of FIGS. 2 to 4, two adjusters 50 may be provided. The two adjusters 50 may be spaced apart. The two adjusters 50 may be located on opposing sides of the pin 31.

A washer 60 may be provided as an intermediate part for positioning between the wear pad 40 and the adjuster 50. In particular, the washer 60 may be positioned between the coupling surface 42 of the wear pad 40 and the contact end 51 of the adjuster 50. The washer 60 may provide a firm surface for the contact end 51 of the adjuster 50 to push against. The washer 60 may additionally act to distribute the load from the adjuster 50. The washer 60 may be planar, having a length and a width that are substantially greater than its thickness. The shape and size of the washer 60 may generally correspond with the shape and size of the wear pad 40, although this is not required as long as the washer 60 is present in a region of the wear pad 40 coupling surface 42 that is acted upon by the contact end 51 of the adjuster 50. As illustrated in the specific embodiment of FIGS. 2 to 4, the washer 60 may have a circular shape. Alternatively, the washer 60 may have a rectangular shape, another polygonal shape, or an irregular shape. As further illustrated in the specific embodiment of FIGS. 2 to 4, the washer 60 may have a larger surface area than the wear pad 40.

The washer 60 may comprise a washer aperture 61. The Washer aperture 61 may be configure to allow the pin 31 of the anchor 30 to pass therethrough. Thus the washer aperture 61 may be larger than the pin 31. As shown in the specific embodiment of FIGS. 2 to 4, the washer aperture 61 may be circular. In particular, the washer 60 of the specific embodiments of FIGS. 2 to 4 is annular. However, the washer aperture 61 may have any other practicable shape, such as a square, rectangular, other polygonal, or an irregular shape.

The washer 60 may be formed from any suitable material. For example the washer 60 may be formed from a cold rolled steel.

The coupling surface 42 of the wear pad 40 may be provided with a locating feature for locating the washer 60 on the wear pad 40. The locating feature may also serve to retain the washer 60 on the wear pad 40. As shown in the specific embodiment of FIGS. 2 to 4, the locating feature may comprise an annular flange 46 extending from the coupling surface 42 of the wear pad 40 in a direction perpendicular to the plane of the coupling surface 42. The annular flange 46 may extend around the wear pad 40 recess 44. The washer aperture 61 may be sized to fit around the flange 46. The washer aperture 61 may be sized to provide a clearance fit with the flange 46, such that the flange 46 is operable to locate the washer 60 on the wear pad but does not retain it. Alternatively, the washer aperture 61 may be sized to provide an interference fit with the flange 46, such that the flange 46 is operable to locate and retain the washer 60 on the wear pad. The term “interference fit” (also known as a “press fit”, “pressed fit”, or “friction fit”) is used herein to mean that the dimensions of a hole and a shaft are such that the hole is smaller than the shaft, such that parts are held together by friction after the parts are pushed together. Optionally, the thickness of the flange 46 and the thickness of the washer 60 may be substantially equal.

A first boom aperture 70 may be provided in the first boom section 21, for receiving the pin 31 of the anchor 30. The first boom aperture 70 may be shaped and sized to fit around the pin 31. As shown in the specific embodiment of FIGS. 2 to 4, the first boom aperture 70 may be circular, to correspond with the circular shape of the pin 31. The first boom aperture 70 may be configured to provide a clearance fit with the pin 31 of the anchor 30, such that the pin 31 of the anchor 30 may be passed through the first boom aperture 70 (and removed therefrom) without the need for force or the use of a tool. Thus the first boom aperture 70 may be larger than the pin 31. At least one second boom aperture 71 may further be provided in the first boom section 21 corresponding to the at least one connecting aperture 37 of the connection portion 35 of the anchor 30. The at least one second boom aperture 71 may be threaded.

To assemble the wear pad assembly 20, first the wear pad 40 and the washer 60 may be coupled together by fitting the washer aperture 61 around the wear pad 40 flange 46 (or, alternatively, inserting the wear pad 40 flange 46 into the washer aperture 61). The wear pad 40 and washer 60 may then be slid along a first side 25 of the first boom section 21, between the first and second boom sections 21,22. The position of the wear pad 40 (and the washer 60) along the first side 25 of the first boom section 21 may be adjusted to visually align the first boom aperture 70 with the wear pad 40 recess 44. When the first boom aperture 70 and the wear pad 40 recess 44 are aligned, the second end 33 of the pin 31 of the anchor 30 may be inserted into the first boom aperture 70 from a second side 24 of the first boom section 21 (the second side 24 of the first boom section 21 opposing the first side 25 of the boom section 21) until the connecting portion 35 of the anchor 30 contacts the first boom section 21, causing the pin 31 to extend into the wear pad 40 recess 44. A circular pin 31 and wear pad 40 recess 44 may be advantageous so that a particular rotational orientation of the wear pad 40 relative to the pin 31 is not required. Alternatively, a square or other polygonal shaped pin 31 and wear pad 40 recess 44 may be advantageous if a particular rotational orientation of the wear pad 40 relative to the pin 31 is desired.

The at least one connecting aperture 37 of the connecting portion 35 of the anchor 30 may be aligned with the at least one second boom aperture 71. The anchor 30 may then be secured to the first boom section 21 by inserting the contact end 51 of an adjuster 50 through each of the at least one connecting aperture 37 of the connecting portion 35 of the anchor 30 and the aligned second boom aperture 71, such that the contact end 51 of the adjuster 50 approaches and contacts the washer 60. The adjustment end 52 of the adjuster 50 may be acted upon to urge the wear pad 40 away from the first side 25 of the first boom section 21 and towards the second boom section 22. In the case of the specific embodiment of FIGS. 2 to 4, the locking nut 54 may be threaded onto the threaded bolt 53 prior to inserting the threaded bolt 53 through the connecting aperture 37 and second boom aperture 71.

The optimal position of the wear pad 40 (along the longitudinal axis 34) between the first and second boom sections 21,22 may be such that a running clearance 72 is present between the sliding surface 43 of the wear pad 40 and the second boom section 22. The running clearance 72 may be set to avoid binding of the first and second boom sections 21,22 due to variation in the first and second boom sections 21,22 along the path of travel (that is, in the sliding direction 80). For example, if a running surface of the first or second boom section 21,22 has a flatness of 2 mm, the running clearance 72 may be set to 3 mm. In the specific embodiment of FIGS. 2 to 4, this may be achieved by acting upon the adjustment end 52 of the threaded bolt 53 to turn the threaded bolt 53 until it is tight, indicating that the sliding surface 43 of the wear pad 4 has reached and contacted the second boom section 22. The threaded bolt 53 may then be loosened by a specified number of turns to achieve the desired running clearance 72. Finally, the locking nut 54 may be tightened to a specified torque.

Thus the anchor 30 is mounted to the first side 25 of the first boom section 21 and the wear pad 40 and washer 60 are located on the second side 24 of the first boom section 21. The wear pad 40 and washer 60 are located between the first boom section 21 and the second boom section 22.

In the assembled wear pad assembly 20 the wear pad 40 and washer 60 are not secured or attached to the anchor 30 or to the first boom section 21. The wear pad 40 and washer 60 contact and engage with the anchor 30 (via the pin 31), but remain detached from it. Similarly, the washer 60 contacts the one or more adjusters 50, but remains detached from the one or more adjusters 50.

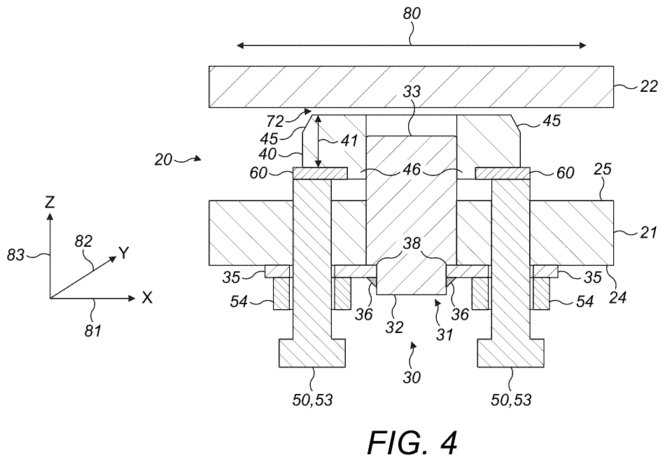

Although the wear pad 40 and washer 60 are not attached to the anchor 30, the wear pad 40 and washer 60 are constrained in use in a Z-direction perpendicular to a plane of the first boom section 21 (as indicated in FIG. 4) by the contact end 51 of the adjuster 50 and the second boom section 22. That is to say, the wear pad 40 and washer 60 are held captive in the Z-direction by and between the contact end 51 of the adjuster 50 and the second boom section 22. The pin 31 of the anchor 30 and corresponding wear pad 40 recess 44 (as well as the one or more adjusters 50) constrain the wear pad assembly 20 in X- and Y-directions in the plane of the first boom section 21 (as indicated in FIG. 4).

A strengthening plate (not shown) may be provided on the second side 24 of the first boom section 21 to strengthen the first boom section 21 in the region of the boom apertures 70,71, the strengthening plate being provided with corresponding apertures. The strengthening plate may be non-releasably attached to the second side 24 of the first boom section 21, for example by welding.

In use, the thickness 41 of the wear pad 40 reduces due to the sliding contact of the second boom section 22 upon it. The wear pad assembly 20 may periodically be checked to monitor the wear of the wear pad 40. In the present disclosure the term “wear” refers to a reduction in thickness from an original, predetermined and pre-installation thickness 41 due to sacrificial removal of the wear pad 40 material resulting from the sliding contact of the second boom section 22 upon the wear pad 40.

If the clearance between the sliding surface 43 of the installed wear pad 40 and the second boom section 22 increases beyond a predetermined size, the wear pad assembly 20 may be adjusted by acting upon the adjustment end 52 of the adjuster 50 to urge the wear pad 40 away from the first side 25 of the first boom section 21 and towards the second boom section 22, to thereby reduce the clearance. The desired running clearance 72 may be achieved in the same manner as described above. When the wear pad 40 reaches the end of its usable life, it can be replaced by a new wear pad 40 having the pre-installation thickness.

### Industrial Applicability

By virtue of being able to adjust the position of the wear pad 40 (along the longitudinal axis 34) between the first and second boom sections 21,22, the wear pad assembly 20 can be tailored to achieve an optimal running clearance 72 between the first and second boom sections 21,22 for a particular telehandler. Furthermore, as the thickness 41 of the wear pad 40 reduces during the life of the wear pad 40, the optimal running clearance 72 can be maintained by urging the wear pad 40 towards the second boom section 22, thereby prolonging the lifetime of the wear pad assembly 20 and thus reducing cost and waste.

Using an adjuster to adjust the position of the wear pad 40 (along the longitudinal axis 34) between the first and second boom sections 21,22 instead of shims means that the wear pad assembly 20 can be adjusted without being disassembled. This may reduce servicing time and thus servicing costs.

Providing a clearance fit between the wear pad 40 and the anchor 30 reduces the complexity of assembling and disassembling the wear pad assembly 20. This is turn may reduce servicing time and thus servicing costs.

Locating the fastening adjuster(s) 50 outside of the load path may result in a hard joint that is resistant loosening. Again, this may reduce servicing requirements and thus costs.

1. A wear pad assembly for an extendable boom having a first boom section and a second boom section, the wear pad assembly comprising:
an anchor for mounting to the first boom section, the anchor comprising a pin extending between a first end and a second end along a longitudinal axis, the anchor further comprising a connecting portion extending outwardly from the first end of the pin in a plane perpendicular to the longitudinal axis, wherein the connecting portion comprises a connecting aperture; and
a wear pad having a thickness extending between a coupling surface and an opposing sliding surface, the coupling surface comprising a recess for engagement with the pin of the anchor; and
an adjuster for adjusting the position of the wear pad along the pin in a direction parallel to the longitudinal axis, the adjuster having a contact end that is inserted through the connecting aperture and contacts the coupling surface of the wear pad.

2. The wear pad assembly according to claim 1, wherein the recess is configured to provide a clearance fit with the pin, in particular wherein the recess is sized and/or shaped to provide the clearance fit with the pin.

3. The wear pad assembly according to claim 1, wherein the pin and the recess are circular.

4. The wear pad assembly according to claim 1, wherein an outer surface of the pin is smooth.

5. The wear pad assembly according to claim 1, wherein a perimeter of the sliding surface of the wear pad comprises a chamfer.

6. The wear pad assembly according to claim 1, wherein the adjuster is configured to be lockable.

7. The wear pad assembly according to claim 1, wherein the adjuster comprises a threaded bolt with a locking nut.

8. The wear pad assembly according to claim 1, wherein the wear pad assembly comprises two or more adjusters.

9. The wear pad assembly according to claim 1, further comprising a washer positioned between the coupling surface of the wear pad and the contact end of the adjuster.

10. The wear pad assembly according to claim 9, wherein the wear pad comprises a locating feature for locating and/or retaining the washer on the wear pad.

11. The wear pad assembly according to claim 10, wherein:
the locating feature comprises an annular flange extending from the coupling surface of the wear pad in a direction perpendicular to a plane of the coupling surface, the annular flange extending around the wear pad recess; and
the washer comprises a washer aperture, the washer aperture being sized to fit around the annular flange.

12. The wear pad assembly according to claim 11, wherein the washer aperture is sized to provide a clearance fit with the annular flange.

13. The wear pad assembly according to claim 11, wherein the washer aperture is sized to provide an interference fit with the annular flange.

14. The extendable boom having a first boom section and a second boom section, the extendable boom comprising a wear pad assembly according to claim 1.

15. The extendable boom according to claim 14, wherein the wear pad assembly is mounted to the first boom section and the second boom section is configured to slide relative to the first boom section along the sliding surface of the wear pad.

16. The extendable boom according to claim 14, wherein:
the wear pad is positioned on a first side of the first boom section, the wear pad being located between the first boom section and the second boom section; and
the anchor is mounted to a second opposing side of the first boom section, the pin extending through a first boom aperture in the first boom section and into the wear pad recess.

17. The extendable boom according to claim 14, wherein the wear pad is constrained in a direction perpendicular to a plane of the first boom section by the contact end of the adjuster and the second boom section.

18. A telehandler comprising an extendable boom according to claim 14.
